(19) United States
(12) Patent Application Publication
(10) Pub. No.: US 2007/0008725 A1
(43) Pub. Date: Jan. 11, 2007

(54) Illumination and irradiation unit for ophthalmologic devices

(76) Inventors: Egon Luther, Cospeda (DE); Ingo Koschmieder, Jena (DE); Jan Buchheister, Jena (DE); Falk Moehr, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/551,685

(22) PCT Filed: Mar. 24, 2004
(86) PCT No.: PCT/EP04/03089

§ 371 Date: Jul. 11, 2006

(30) Foreign Application Priority Data
Apr. 2, 2003 (DE) 10314944.9

(51) Int. Cl. F21S 6/00

(52) U.S. Cl. 362/257

(57) ABSTRACT

The invention relates to an assembly for generating a variable illumination for diagnosis and therapy, in particular of the human eye. The illumination and irradiation unit consists of an illumination source that emits light, elements for generating special illumination patterns and/or profiles, in addition to elements for coupling the light from the light source into the parallel beam path of the viewing system of the ophthalmologic device. The inventive solution generates different marks, patterns and profiles and can also be used both for diagnosis and therapy in ophthalmology. The illumination unit is therefore suitable for different ophthalmologic devices. It can also be configured as a modular unit for retroactive assembly in the parallel beam path of an ophthalmologic device. To achieve this, a beam divider that is already present in the respective ophthalmologic device is used. The illumination and irradiation unit can also be used as an independent unit or as an auxiliary unit for various ophthalmologic devices, such as slit lamps, fundus cameras, laser scanners, ophthalmoscopes and operating microscope systems.

### CROSS REFERENCE TO RELATED APPLICATIONS

This application claims priority of International Application No. PCT/EP2004/003089, filed Mar. 24 2004 and German Application No. 103 14 944.9, filed Apr. 2, 2003, the complete disclosures of which are hereby incorporated by reference.

### BACKGROUND OF THE INVENTION

a) Field of the Invention

The present invention is directed to an arrangement for the generation of a variable illumination for diagnosis and therapy, particularly for the human eye. The illuminated object can be an artificial object as well as biological tissue, for example, an eye. As regards an eye, it is possible to irradiate the lens of the eye as well as other portions of the eye such as the cornea or retina.

b) Description of the Related Art

In particular, the solution can also be used to fine-tune optically active molded articles that are introduced in the eye, e.g., lenses of plastic, when these molded articles are made of various photosensitive plastics according to WO 00/41650 and/or WO 01/71411. With these types of lenses, polymerization processes are triggered by irradiation resulting in irreversible chemical changes in the lens substance. Through these processes, the refractive index and/or the transmission behavior for the visible effective radiation, or the geometric shape of the lenses, can be changed in a defined manner and it is therefore possible to improve defective vision.

Patents WO 00/41650 and WO 01/71411 describe lenses, particularly intraocular lenses (IOL), in which the polymerization of a polymer matrix contained in the lens can be excited by irradiation and the refractive index or the shape of the overall lens can accordingly be changed. With implanted IOLs, the problem occurs in approximately one half of patients that an acceptable visual power can only be achieved by means of additional corrective means such as spectacles or contact lenses. This results from measurement errors in eye measurements, deviations in the positioning of the IOL and/or from healing processes. It is possible to correct an IOL of the kind mentioned above that has already been implanted by means of deliberate irradiation by adapting to the actual given circumstances by changing the refractive index, the transmission characteristics or the shape. The irradiation of the IOLs for exciting the polymerization process is preferably carried out by means of laser sources or lamps which transmit a high UV component of light. In this case, an He/Cd laser or an Xe/Hg lamp serves as irradiation source. The illumination structures that may be required are generally generated by means of mechanical shutters and/or filters.

The solution described in WO 02/26121 is directed to a process and an arrangement for the irradiation of light-adjustable lenses, preferably of plastic lenses which are implanted in the eye. The patterns and profiles required for the irradiation, as well as the duration thereof, are determined on the basis of data that have been measured beforehand and are coupled into the illumination beam path by means of a beamsplitter. The effect achieved by the irradiation can be monitored by means of a wavefront analysis.

A process and an arrangement for the examination of the fundus of the eye are described in DE 100 42 718. In order to ensure the most continuous possible image recording with non-harmful irradiation, an infrared component of the illumination light and a visible component of the illumination light are alternately passed through filter arrangements. The fact that the optical axes of the observation beam path and the illumination beam path do not coincide has disadvantageous consequences.

DE 199 43 735 A1 describes a method and an arrangement for directed irradiation of an eye by means of light from the visible and/or near infrared wavelength ranges. The irradiation produces irreversible chemical changes in the eye lens substance resulting in a change in the refractive index and/or in the transmission characteristics for the visible effective radiation so that it is possible to improve defective vision. For successful treatment, the distribution of the refractive power of the eye to be treated must be determined as continuously and completely as possible. The desired refractive power distribution following treatment and the data about the irradiation which is required for this are determined from these values. In this solution, it is disadvantageous that the irradiation can generally only be carried out successively point by point so that the treatment process is time-consuming. Therefore, fixation of the eyeball for the duration of treatment is indispensable.

DE 198 12 050 A1 describes a method and an arrangement for illumination in an ophthalmic microscope. A wide variety of light mark geometries is generated by means of optoelectronic components and are projected on the anterior and posterior portions of the eye. This solution is used for general examination of the eye. An arrangement for generating section images in transparent media is provided in the as-yet-unpublished DE 101 55 464.8. Another unpublished reference (DE 101 51 314.3) describes an ophthalmic examination instrument which makes possible a parametric examination in addition to a general examination of the eye. The solutions in both of these references likewise provide for the use of optoelectronic components to generate the illumination marks and illumination patterns.

However, arrangements of the type mentioned above have the disadvantage that the observation field is sometimes not illuminated in its entirety in case of lateral illumination or that imaging errors can result from the use of link systems for coupling in the illumination beam. Further, costly technical solutions are sometimes required for coupling in the illumination radiation.

### OBJECT AND SUMMARY OF THE INVENTION

It is the primary object of the present invention to develop a unit for ophthalmic instruments for illuminating and/or irradiating the human eye for purposes of observation and/or treatment. The proven design of the ophthalmic instruments is retained and their construction is not made substantially more complicated.

According to the invention, this object is met in an illuminating and irradiating unit for ophthalmic instruments comprising an illumination source, means for generating specific illumination patterns and/or profiles and means for coupling light from the illumination source onto the parallel beam path of the observation system of the ophthalmic instrument.

The present invention is directed to an illuminating and irradiating unit for generating different marks, patterns and profiles and can accordingly be used for diagnosis and therapy in ophthalmology. The illumination unit is suitable for different ophthalmic instruments.

The technical solution is described in the following with reference to an embodiment example.

### BRIEF DESCRIPTION OF THE DRAWING

In the drawing:

FIGURE 1 shows the basic construction of the proposed illuminating and irradiating unit with a slit lamp.

### DESCRIPTION OF THE PREFERRED EMBODIMENTS

The illumination unit for ophthalmic instruments comprises an illumination source 1, means for generating, monitoring and controlling illumination patterns and/or profiles, means for coupling the illumination light into the parallel beam path of the observation system of the ophthalmic instrument, and a central controlling and evaluating unit.

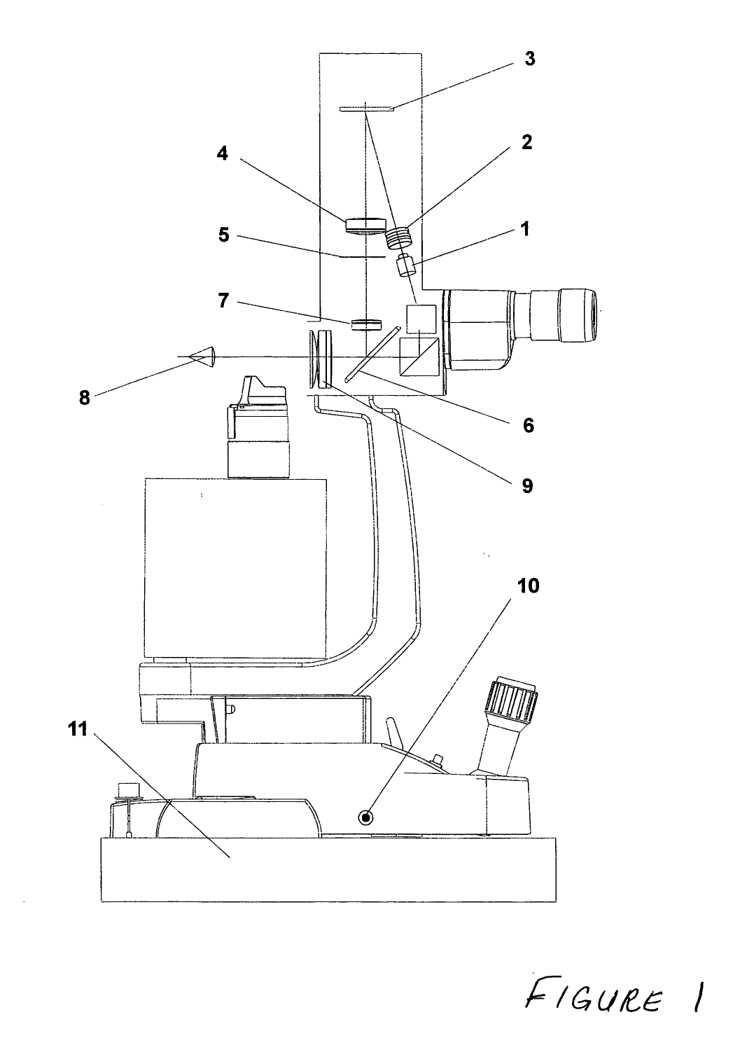

FIGURE 1 shows an illuminating and irradiating unit for a slit lamp in which the illumination source 1 is a narrow-band light in the short-wavelength range around 365 nm. The light bundle generated by the illumination source 1, e.g., an arc lamp, is directed by the condenser group 2 to the means for generating illumination patterns and/or profiles. These means can be fixed or exchangeable optical filters and/or diaphragms or can also be optoelectronic light modulators 3. For example, a DMD (digital micromirror device) microdisplay or a LCOS (liquid crystal on silicon) reflecting microdisplay can be used as an optoelectronic light modulator 3. Transmissive LCD (liquid crystal display), self-luminous LED (light emitting diode) or OLED (organic light emitting diode) optoelectronic light modulators 3 can also be used. The control of the optoelectronic light modulators 3 which can work based on transmission or reflection is carried out by means of a control unit (not shown). Optional patterns, profiles and distributions can be used by these arrangements to generate a wide variety of effects. The spectral and spatial range of the illumination beam can be influenced by optical filters 4 and/or diaphragms 5. The spectral bandwidth of the illumination radiation is limited to 365 nm+/−5 nm, for example, by suitable filters 4.

A beamsplitter 6 which is used for coupling in light from the illumination source 1 simultaneously serves as a blocking filter to protect the observer from excessive levels of irradiation by short-wavelength illumination light. The generated illumination pattern is directed by projection optics 7 to the beamsplitter 6 that can be constructed as a mirror or cube and is imaged directly into the patient's eye 8 via the objective 9 arranged in the observation beam path. This objective 9 which is arranged in the observation beam path is preferably corrected in the UV and/or VIS range of light. To ensure an unimpeded simultaneous observation of the patient's eye 8 by the observer, the beamsplitter 6 is transparent for light from the VIS range. The back of the beamsplitter 6 is constructed as a blocking filter to protect the observer from excessive levels of short-wavelength irradiation.

In another construction of the illuminating and irradiating unit for different ophthalmic instruments, the illumination source 1 is arranged as a separate structural component part outside of the actual illumination unit.

The connection to the means for generating special illumination patterns and/or profiles which are located in the illumination unit is produced by light guides.

Further, the illuminating and irradiating unit can have a monitoring unit for monitoring the radiation dose, for recording the irradiation pattern, and for registering the irradiated positions. The monitoring unit preferably has one or more interfaces 10 for transferring data. A computer which can be integrated, for example, in the base 11 of the slit lamp can be used as a monitoring unit.

For other applications, e.g., photodynamic therapy (PDT), it is advantageous that narrow-band, long-wavelength light, preferably around 690 nm, is emitted by the illumination source 1. According to FIGURE 1, the generated light bundles are deflected by the condenser group 2 to the means for generating illumination patterns and/or profiles. These means can be fixed or exchangeable optical filters 4 and/or diaphragms 5 or can also be optoelectronic light modulators 3.

FIGURE 1 shows a particular embodiment form of the illuminating and irradiating unit for a slit lamp. The illuminating and irradiating unit is provided in a separate housing as a possible auxiliary unit or retrofit unit for various ophthalmic instruments. The proven design of known ophthalmic instruments is also retained in this embodiment form.

Optional patterns, profiles and distributions can be generated through the use of filters 4, diaphragms 5 and particularly optoelectronic light modulators 3 so that a wide variety of effects can be produced on or in the patient's eye 8.

An eyetracker unit (not shown) which is provided in addition is used for monitoring possible eye movements, monitoring the orientation of the illumination patterns on the areas to be irradiated during irradiation and/or for tracking the illumination patterns. The tracking of the illumination patterns can be carried out mechanically as well as optically. When the illumination pattern radially or laterally exceeds a certain previously determined tolerance value for a time period that has likewise been determined beforehand, the irradiation can be interrupted and continued only when the targeted state has been achieved again. Further, the time period for irradiation can be evaluated in order not to exceed the respective radiation dose. However it is also possible for the illumination pattern to follow the eye movement.

Combining with a wavefront measuring unit and/or a topography system and/or an eye axis length measurement unit is particularly advantageous for generating the corresponding illumination patterns. The wavefront measuring unit and/or the topography system and/or the eye axis length measurement unit can be located in a shared housing with the illuminating and irradiating unit or can also be integrated in the base 11 of the slit lamp.

In the proposed solution, it has proven especially advantageous to couple the generated illumination patterns and illumination profiles into the observation system, e.g., the observation microscope of a slit lamp. This makes it possible to work without hindrance with the proven compact mechanical-optical design of ophthalmic instruments. Further, this has the advantage that the illumination beams run coaxial with the observation beams. When the in-coupling point of the illumination beam is situated in the parallel beam path of a Galilean system, there are hardly any imaging errors, e.g., astigmatism, in contrast to the link system that is used outside of the observation beam path. In addition, the occurrence of astigmatism and a possible image offset or additional contamination must be taken into account when an external mirror is used.

The proposed technical solution can also be conceived as a modular unit for retrofit installation in the parallel beam path of an ophthalmic instrument. In addition, a beamsplitter already existing in the respective ophthalmic instrument is used. The illuminating and irradiating unit can accordingly be used as an independent unit or as an additional unit for different ophthalmic instruments such as slit lamps, fundus cameras, laser scanners, ophthalmoscopes and OPMI devices.

While the foregoing description and drawings represent the present invention, it will be obvious to those skilled in the art that various changes may be made therein without departing from the true spirit and scope of the present invention.

1-12. (canceled)

13. An illuminating and irradiating unit for ophthalmic instruments, comprising:
an illumination source;
means for generating specific illumination patterns and/or profiles; and
means for coupling light from the illumination source into the parallel beam path of the observation system of the ophthalmic instrument.

14. The illuminating and irradiating unit according to claim 13 which has, in addition, a monitoring unit for monitoring the radiation dose, for recording the irradiation patterns, and for registering the irradiated positions.

15. The illuminating and irradiating unit according to claim 13, wherein the monitoring unit has one or more interfaces for transferring data.

16. The illuminating and irradiating unit according to claim 13, wherein the illumination source generates narrow-band light in the short-wavelength range.

17. The illuminating and irradiating unit according to claim 16, wherein the illumination source generates narrow-band light around 365 nm.

18. The illuminating and irradiating unit according to claim 13, wherein the illumination source generates narrow-band light in the long-wavelength range.

19. The illuminating and irradiating unit according to claim 18, wherein the illumination source generates narrow-band light around 690 nm.

20. The illuminating and irradiating unit according to claim 13, wherein optical filters, diaphragms and/or optoelectronic light modulators with a control unit are used as means for generating specific illumination patterns and/or profiles.

21. The illuminating and irradiating unit according to claim 13, wherein a beamsplitter which is used for coupling in light from the illumination source simultaneously serves as a blocking filter to protect the observer from excessive levels of irradiation by the illumination light.

22. The illuminating and irradiating unit according to claim 13, wherein the illumination source is not arranged within the illumination unit but rather as a separate structural component part and is connected to the means for generating specific illumination patterns and/or profiles by means of a light guide.

23. The illuminating and irradiating unit according to claim 13, wherein an eyetracker unit is provided in addition for monitoring the orientation of the illumination patterns on the areas to be irradiated during irradiation and/or for tracking.

24. The illuminating and irradiating unit according to claim 13, which is conceived as a modular unit for retrofit installation in the parallel beam path of an ophthalmic instrument.

25. The illuminating and irradiating unit according to claim 13, which can be used in combination with subassemblies such as a wavefront measuring unit and/or a topography system and/or an eye axis length measurement device for different ophthalmic instruments.

26. The illuminating and irradiating unit according to claim 13, which can be arranged in a shared housing with other subassemblies such as a wavefront measuring unit and/or a topography system and/or an eye axis length measuring device.
